(19) United States
(12) Patent Application Publication
(10) Pub. No.: US 2009/0185321 A1
(43) Pub. Date: Jul. 23, 2009

(54) DEVICE AND METHOD FOR THE EXTENDED PROTECTION OF ELECTRIC LINES

(75) Inventors: José Luis Diaz Mejia, Condes (Palencia) (ES); Jesus Angel Oroz Garcia, Condes (Palencia) (ES)

Correspondence Address: RENNER OTTO BOISSELLE & SKLAR, LLP, 1621 EUCLID AVENUE, NINETEENTH FLOOR, CLEVELAND, OH, 44115, US

(73) Assignee: CREYDEC S.L., Palencia (ES)

(21) Appl. No.: 10/599,212

(22) PCT Filed: Mar. 22, 2005
(86) PCT No.: PCT/EP2005/003035

§ 371 Date: Dec. 17, 2008

(30) Foreign Application Priority Data
Mar. 22, 2004 (ES) P200400700

(51) Int. Cl. H02H 3/20

(52) U.S. Cl. 361/91.1

(57) ABSTRACT

Device for the protection of electric lines which comprises: processing means; power supply means; voltage measurement means; means of alert; and switching means which alternatively send the line's own current through a main branch (which comprises the remaining components) or through a branch line; and method for the protection of electric lines by means of the device in accordance with the invention, which comprises: normal operating mode—safety element in perfect condition and inactive protection device; boundary anomalous operating mode—the intensity circulating through the safety element surpasses a caution threshold and the protection device signals said condition; and line verification anomalous operating mode—after failure of the safety element, all the current flows through the protection device and the protection device detects, signals, and analyses said condition.

### OBJECT OF INVENTION

This invention refers to a device and a method for extended protection of electric lines, which provide essential innovative characteristics and significant advantages over the known devices and methods used for the same objects in the current state of the art.

More specifically, this invention refers to an electric/electronic device and an operating method thereof designed to provide electric lines (whether they are supply lines or signal transmission lines) with extended protection which includes both continuous verification of the line's condition and identification of the causes of potential anomalous conditions thereof.

### BACKGROUND OF INVENTION

Electronic and electric circuits are generally supported by safety elements, which offer a certain protection and facilitate restoring of the circuit in the event of a potential overload. These circuit safety elements exhibit, however, several drawbacks.

In the case of circuits protected by flux plate elements, it is difficult to visually distinguish if the safety element is fused or not, and the cause of malfunction in the circuit or any unit supplying it cannot be determined. The line may even be functioning at the limit of the circuit's nominal current, such that the safety element will exhibit a change of the resistance, thus preventing the units it supplies from correctly operating, but it will not indicate the line's anomalous condition.

On the other hand, in circuits protected by other safety elements, such as thermal switches or resettable fuses, the handling of the lever or button for reactivation is easy, but this type of safety element also does not allow to determine the cause of malfunction in the circuit or any unit supplying it, which makes repeated reactivations necessary, leading to rapid deterioration of the safety element.

### SUMMARY OF THE INVENTION

The present invention addresses the above-mentioned problems by means of a device and a method for the protection of electric lines which allow the continuous verification of the line's condition and identification of the causes of potential anomalous conditions thereof.

Consequently, according to a first embodiment of the present invention, an electric/electronic protection device for electric lines is provided, in parallel with a safety element at the entrance to a unit that is to be preserved, which comprises: processing means which control and functionally link the remaining device components to one another; power supply means which supply the processing means during anomalous line conditions, at least in the absence of the line's own power supply; voltage measurement means which measure anomalous local voltages; means of alert which signal the conditions detected by the device; and switching means which alternatively lead the line's own supply to supply the remaining device components (main branch) or the line's own supply to avoid the remaining device components through a branching of the device (branch line).

The means of alert may be of various types, depending on the action to be performed in view of the invention's specific application. Solely as an example, said means of alert may simply include an array of LED-type signallers, whose selective excitation notifies the user of the respective conditions of the line under verification, or an LCD-type signaller which, in addition, provides the user with data on the conditions of the line under verification, or they may include a transmitter which transmits a signal to a remote line surveillance centre, etc., or even a combination of several means.

Moreover, the invention device may optionally also comprises a load laid out in such a way that, when the switching means are in a branching condition, it prevents the device from short-circuiting.

The invention device exhibits the specificity that it may be installed in a permanent manner, such that it remains permanently linked to the line and reacts in real time to contingencies thereof, i.e. the invention device allows for continuous verification of both the safety element and the units that are supplied by connection to the terminals where the invention device is also laid out.

In accordance, now, with a second embodiment of the invention, a method for the protection of electric lines is provided, which includes three operating modes depending on the line's condition:

Normal operating mode: the safety element is in perfect condition and the intensity it bears is within the nominal operating range; thus, the safety element exhibits a basically null resistance and, consequently, virtually all the electric current flows through it.

The protection device's voltage measurement means do not measure any potential drop and the protection device remains inactive.

Boundary anomalous operating mode: the intensity circulating through the safety element rises above the nominal operating margin, until it surpasses a pre-determined caution threshold, which entails a temperature close to that of the safety element's breakdown or trigger point, and, consequently, a change of the resistance thereof (the value of this resistance and the duration thereof are design variables which depend on the nominal impedance and other intrinsic line parameters, primarily the maximum power that the emitting source may supply).

Therefore, part of the current flows to the invention protection device and, due to the switching means' default condition, is diverted to the main branch. The processing means receive a signal from the voltage measurement means, in relation to a voltage that rises until reaching, at least, a value corresponding to said caution threshold, and enable a corresponding control signal to the means of alert.

Line verification anomalous operating mode: after failure (breakdown or trigger) of the safety element, all the current flows through the invention protection device and, due to the switching means' default condition, is diverted to the main branch.

The processing means receive a signal from the voltage measurement means, in relation to a voltage that rises until reaching, at least, the failure point. The processing means then initiate an operating cycle which includes enabling a control signal to the switching means so that they divert the current to the branch line (maintaining the switching means in that condition using the voltage provided by the now active power supply means), processing the line parameters to verify the line's condition, enabling a control signal to the means of alert corresponding to the line's condition, and enabling a control signal to the switching means in order that they once again divert the current to the main branch.

If required, due to the nature and layout of the voltage measurement means, the processing means enable an additional control signal to the voltage measurement means so that they go into disconnection mode when the current has to be diverted to the branch line.

### BRIEF DESCRIPTION OF THE DRAWINGS

Additional characteristics and advantages of the invention will be more clearly observed from the following detailed description of a preferred embodiment, which is given solely for illustration purposes, and is not limited thereto, in reference to the attached drawings, where:

FIG. 1 shows a block diagram of the invention protection device;

FIG. 2 shows an electric diagram of a first embodiment of the invention protection device; and

FIG. 3 shows an electric diagram of a second embodiment of the invention protection device.

### DESCRIPTION OF THE INVENTION EMBODIMENTS

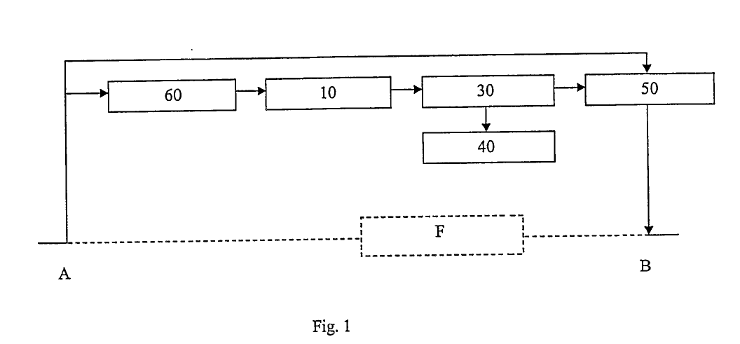

In reference to FIG. 1, it shows a block diagram which illustrates the grounds for a protection device in accordance with this invention, located in a line safety element F such that said protection device remains permanently linked to the line and reacts in real time to contingencies thereof, that is, said protection device allows for continuous control of both said safety element F and the circuits that are supplied by connection to terminals A, B, to which said protection device is also connected. Therefore, said protection device will act as a link between the power supply source or the transmission source for a given type of signal, and the circuit it is desired to protect.

The protection device comprises a main branch which includes power supply means 60, as well as voltage measurement means 10 and processing means 30 supplied by said power supply means 60. In addition, said processing means 30 are provided with means of alert 40. In addition, the protection device comprises a branch line, in parallel with said main branch. Both branches, the main branch and the branch line, converge on switching means 50.

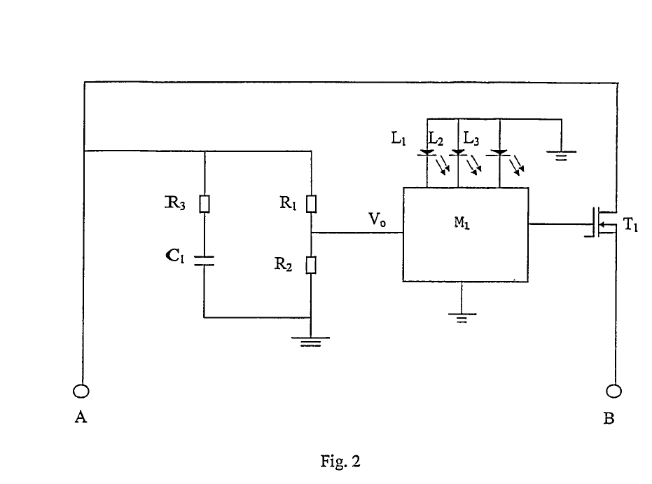

In reference now to FIG. 2, it shows a first, basic embodiment of the protection device in accordance with this invention. In this embodiment, power supply means 60 comprise a condenser C₁, voltage measurement means 10 comprise a resistance layout R₁, R₂, R₃, processing means 30 comprise a microprocessor M₁, and means of alert 40 comprise a layout of LED-type signallers L₁, L₂, L₃.

As may be seen in FIG. 2, the switching means 50 comprises a transistor T₁, of the n-channel MOSFET type.

In this embodiment, if the current through the safety element F (not shown in order to simplify the illustration), located between terminals A, B of the protection device, is within a normal operating range, said safety element F exhibits a basically null resistance and, consequently, virtually all the current flows through it. The protection device does not receive any current and remains inactive.

On the other hand, if the current through the safety element rises until it surpasses a caution threshold (pre-defined by a voltage drop Vu through said safety element), with the safety element changing the resistance and thus exhibiting a certain resistance, part of the current arriving at terminals A, B will be diverted to the protection device and, since transistor T₁'s default condition is disconnection, said amount of current will flow through the main branch of the protection device, i.e. through the resistance layout R₁, R₂, R₃. Microprocessor M₁ will then be supplied with a signal, will interpret said signal as a boundary anomalous functioning condition, and will in turn enable a signal to a corresponding signaller L₁ which indicates said condition.

Finally, if the current through the safety element rises until it surpasses the failure point (breakdown or trigger) (pre-defined by a voltage drop V_{R} through said safety element) of the safety element, virtually all the current flows to the protection device according to the present invention and, since transistor T₁'s default condition is disconnection, said current will flow through the main branch of the protection device, i.e. the resistance layout R₁, R₂, R₃, additionally charging condenser C₁.

Microprocessor M₁ will then be supplied with a signal, will interpret said signal as a line verification anomalous operating condition, and will in turn enable a signal to a corresponding signaller L₂ which indicates said condition and a signal to transistor T₁, which will then go on to be in the saturation region (conduction state).

During the time when said transistor T₁ is in a conduction state (for instance, 100 μs), microprocessor M₁ maintains processing of measurement of the supplied signal thanks to the power supply received from condenser C₁, which, with said transistor T₁ in conduction state, goes on to be in a discharge state.

During this 100-μs period, microprocessor M₁ analyses the line parameters and, if the analysed parameters indicate a short-circuit in the line, microprocessor M₁ also enables a signal to a corresponding signaller L₃ which will switch on L₃ after the 100-μs period.

At the conclusion of this 100-μs period, microprocessor M₁ disables the signal to said transistor T₁, with said transistor T₁ then returning to the disconnection condition, making the current flow once again through the main branch of the protection device.

When this point is reached, microprocessor M₁ will be programmed to enable the signal to said transistor T₁ periodically, at least a pre-determined number of times, during said 100-μs period, in order to maintain continuous verification of the line.

Evidently, both the enabling time for the signal to said transistor T₁ (set as 100 μs in this embodiment as an example) and the enabling period of the signal to said transistor T₁, and the number of enablings of the signal to said transistor T₁ will be dimensioned on the basis of the line's design parameters in order to prevent the line and the units it supplies from suffering damage.

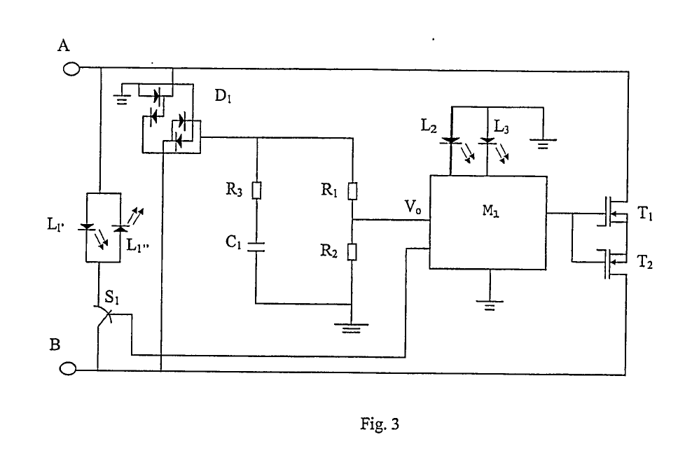

In reference now to FIG. 3, where the components similar to those in FIG. 2 have identical references, it shows a second, alternative embodiment of the protection device in accordance with this invention.

Considering that said second embodiment is a development of the first embodiment described in detail herein, and in order to avoid repetitions, the specific features of said second embodiment will be described below with occasional references to said first embodiment.

Specifically, said second embodiment incorporates to the first embodiment a rectifier D₁ which makes it possible to use the protection device regardless of the line polarity, with said rectifier D₁ being a diode bridge connected to both terminals A, B and to the main branch of the protection device. The configuration process for said rectifiers is well-known in the art and there exist many technically equivalent variants thereof.

Alternatively to the rectifier or in addition to the rectifier said second embodiment also incorporates to the first embodiment a second transistor T₂, of an n-channel MOSFET type as in the case of T₁, symmetrically positioned in opposition to transistor T₁. This transistor layout T₁, T₂ constitutes the switching means in this embodiment.

Moreover, said second embodiment incorporates to the first embodiment an alternative main branch which directly connects terminals A, B to each other, with the mediation of additional voltage measurement means L_{1′}, L_{1″} (which in this case also act as additional means of alert) and means of disconnection S₁.

Said alternative main branch ensures that the protection device in the second embodiment correctly operates with highly sensitive safety elements, i.e. safety elements that reach their failure point exhibiting a relatively low resistance. In this case, the main branch may exhibit a high load in relation to the maximum load (just before the failure point) in the safety element, such that the greater part of the current diverted towards the protection device during a condition of boundary anomalous operation may be insufficient for microprocessor M₁ to act.

Said additional voltage measurement means are composed, in this embodiment, of a layout of LED-type signallers L_{1′}, L_{1″} (which act as additional means of alert and, in the event that they are laid out in an alternative main branch which is a part of a protection device as illustrated in the first embodiment, would be composed of a single LED-type signaller duly laid out taking into account the line polarity) and said means of disconnection S₁ are composed, in his embodiment, of a normally closed relay.

Bearing in mind the presence of said rectifier D₁, said transistor layout T₁, T₂, and said alternative main branch, in this second embodiment the operation would be the following:

Normal operation (V_{AB}˜0): The safety element exhibits a basically null resistance, consequently, virtually all the current flows through it, and the protection device does not receive any current and remains inactive.

Boundary anomalous operation (V_{U}<|V_{AB}|<V_{R}, where V_{U} is the voltage corresponding to the above-mentioned caution threshold and V_{R} is the voltage corresponding to the safety element's breakdown point): The safety element exhibits a certain resistance and part of the current arriving at terminals A, B is diverted to the protection device. Since the default condition for both transistors. T₁ and T₂ is disconnection, the default condition of said relay S₁ is conduction, and the load of the main branch is high in relation to the safety element's load, said amount of diverted current flows through the alternative main branch of the protection device, that is, through the layout of LED-type signallers L_{1′}, L_{1″}. The corresponding signaller L_{1′; L}_{1″} is excited and microprocessor M₁ remains inactive.

Line verification anomalous operation (V_{AB}>0 and |V_{AB}|>V_{R}, where V_{R} is the voltage corresponding to the safety element's breakdown point): All the current flows to the invention protection device and, since the default condition for both transistors T₁ and T₂ is disconnection, said current is divided between the main branch and the alternative main branch of the protection device. The current circulating through the main branch is now sufficient to activate microprocessor M₁ in order to send an opening signal to relay S₁. Thus, all the current will then flow through the main branch, i.e. through the resistance layout R₁, R₂, R₃, additionally charging condenser C₁. Microprocessor M₁ is then supplied with a signal coming from the resistance layout R₁, R₂, R₃, it interprets said signal as a line verification anomalous operating condition, and, in turn, enables a signal to a corresponding signaller L₂ which indicates said condition and a signal to said transistors T₁ and T₂, which will then go on to be in a conduction state. Thanks to the symmetrically opposed layout of said transistors T₁ and T₂, T₁ will only permit passage of current through it, but T₂ will be transformed into a resistance, such that the overall operation will be, in all other respects, analogous to that of the first embodiment.

Line verification anomalous operation (V_{AB}<0 and |V_{AB}|>V_{R}, where V_{R} is the voltage corresponding to the safety element's breakdown point): All the current flows to the invention protection device and, since the default condition for both transistors T₁ and T₂ is disconnection, said current is divided between the main branch and the alternative main branch of the protection device. The current circulating through the main branch is now sufficient to activate microprocessor M₁ in order to send an opening signal to relay S₁. In this way, all the current will then flow through the main branch, that is, the resistance layout R₁, R₂, R₃, additionally charging condenser C₁. Microprocessor M₁ is then supplied with a signal coming from the resistance layout R₁, R₂, R₃, it interprets said signal as a line verification anomalous operating condition, and, in turn, enables a signal to a corresponding signaller L₂ which indicates said condition and a signal to said transistors T₁ and T₂, which will then go on to be in a conduction state. Thanks to the symmetrically opposed layout of said transistors T₁ and T₂, T₂ will only permit passage of current through it, but T₁ will become a resistance, such that the overall operation will be, in all other respects, analogous to that of the first embodiment.

Both in the embodiment in FIG. 2 and the embodiment of FIG. 3, those skilled in the art will understand that conventionally adequate components must be arranged for perfect operation of the device, depending on the specific application of the protection device.

In this sense, solely as a non-limiting example, condenser C₁ may be supplemented with conventional stabilisation means such as a Zener-type diode mounted in parallel with said condenser C₁.

Likewise, specifically in the second embodiment, the transistor layout T₁ and T₂ may be supplemented by means to reduce the gate-source voltage of transistor T₁ or T₂ (depending on the line polarity) during the initial stabilisation period of microprocessor M₁.

Similarly, in both the embodiment in FIG. 2 and the embodiment in FIG. 3, those skilled in the art will understand that the design values for V_{U} and V_{R} (pre-defined, respectively, for the caution threshold and the failure point) will be determined bearing in mind the line parameters and the desired safety level, with Vᵤ coming to be practically zero for high-safety and/or high-sensitivity applications.

Naturally, if the principle of the invention is maintained, the embodiments and construction details may be widely varied with respect to the above descriptions and illustrations without, as a result, departing the scope of the present invention.

Such variations may affect the shape, the size, and/or the manufacturing materials of the device's physical components and, of course, the implementation characteristics of the required software.

Solely for illustrative purposes, the following examples may be cited.

As has already been mentioned, the means of alert may simply include an array of LED-type signallers, as in the described embodiments, whose selective excitation notifies the user of the respective conditions of the line under verification, or may include an LCD-type signaller, which, in addition, notifies the user of the conditions of the line under verification, or may include a transmitter which transmits a signal to a remote line surveillance centre, etc.; or they may even consist of a combination of several means.

Likewise, the processing means may comprise a microprocessor, as in the described embodiments, or may include an equivalent analogue circuit, or may include an analogue circuit expressly designed for a specific application.

Likewise, the entire device or a part thereof may be manufactured in an integrated-circuit chip.

Naturally, in the event that a microprocessor is used for any task, the internal software thereof will depend on the specific application and the corresponding specific design parameters for the line.

Moreover, the power supply means may include capacitive means, as in the described embodiments, or may include an external supply source, such as for instance a battery, which supplements or replaces said capacitive means.

Finally, a layout within the scope of the invention would consist of multiple invention protection devices, sharing a single set of processing means, to protect corresponding multiple safety elements with their respective circuits.

1. Device for the protection of electric lines, located in parallel with a safety element (F) at the entrance to a unit that is to be preserved, characterised by comprising:
a) processing means (30) which control and functionally link the remaining device components to one another;
b) power supply means (60) which supply the processing means (30) during anomalous line conditions, at least in the absence of the line's own supply;
c) voltage measurement means (10) which measure anomalous local voltages;
d) means (30) for generating an alert signal reflecting the conditions detected by the device; and
e) switching means (50) which alternatively lead the line's own supply to supply the remaining device components (main branch) or the line' s own supply to avoid the remaining device components through a branching of the device (branch line).

2. Protection device for electric lines according to claim 1 by further comprising alert means (40) optically signalling the conditions detected by the device in response to the said alert signal.

3. Protection device for electric lines according to claim 1, characterised in that it is installed in a permanent manner.

4. Protection device for electric lines according to claim 1, characterised in that it comprises a load arranged outside said main branch.

5. Protection device for electric lines according to claim 1, characterised in that said means of alert (40) comprise at least one LED-type signaller and/or at least one LCD-type viewing device and/or a transmitter layout.

6. Protection device for electric lines according to claim 1, characterised in that said processing means (30) comprise an analogue circuit or a microprocessor.

7. Protection device for electric lines according to claim 1, characterised in that said power supply means (60) comprise:
a) capacitive means preferably comprising a condenser; or
b) capacitive means preferably comprising a condenser, and stabilisation means preferably comprising a Zener-type diode; and/or
c) an external supply source preferably comprising a battery.

8. Protection device for electric lines according to claim 1, characterised in that said voltage measurement means (10) comprise a resistance layout.

9. Protection device for electric lines according to claim 1, characterised in that said switching means (50) comprise:
a) at least one transistor preferably being an n-channel MOSFET type transistor; or
b) a relay.

10. Protection device for electric lines according to claim 1, characterised in that it comprises a rectifier (Dl) preferably being a diode bridge to ensure a constant polarity in the protection device.

11. Protection device for electric lines according to claim 1, characterised in that said switching means comprise:
a) a first and a second n-channel MOSFET type transistors, laid out symmetrically in series such that their gates are connected to each other and to the processing means, and their drains are directly connected to each other, and in that said main branch is connected on one end to said switching means (50) and, on the other, to both terminals of the protection device by means of a rectifier; and preferably said switching means (50) comprise, in addition:
b) a diode bridge as rectifier.

12. Protection device for electric lines according to claim 1, characterised in that it comprises an alternative main branch which includes disconnection means preferably comprising a relay, and additional voltage measurement means (10) preferably comprising additional means of alert preferably comprising at least LED-type signaller, connected to said processing means (30).

13. Protection device for electric lines according to claim 1, characterised in that said processing means (30) are shared with other protection devices according to any one of the preceding claims.

14. Protection device for electric lines according to claim 1, characterised in that at least part of said protection device is manufactured in an integrated-circuit chip.

15. Method for the protection of electric lines by means of the device according to claim 1, characterised in that it includes three operating modes depending on the line's condition:
a) Normal operating mode, in which the safety element (F) is in perfect state and the intensity it bears is within a nominal operating range; thus, the safety element (F) exhibits a basically null resistance and, consequently, virtually all the electric current flows through it (the voltage measurement means (10) of the protection device do not measure a potential drop and the protection device remains inactive);
b) Boundary anomalous operating mode, in which the intensity circulating through the safety element (F) rises above the nominal operating margin, until it surpasses a pre-determined caution threshold, which entails a temperature close to that of the safety element's breakdown or trigger point and, consequently, a change of the resistance thereof (part of the current, therefore, flows to the protection device and, due to the switching means' default condition, is diverted to the main branch, where the processing means (30) receive a signal from the voltage measurement means (10), in relation to a voltage that rises until reaching, at least, a value corresponding to said caution threshold, and enable a corresponding control signal to the means of alert); and
c) Line verification anomalous operating mode, in which, after failure (breakdown or trigger) of the safety element, all the current flows through the protection device and, due to the switching means' default condition, is diverted to the main branch, where the processing means (30) receive a signal from the voltage measurement means (10), in relation to a voltage that rises until reaching, at least, the failure point, and they then initiate an operating cycle which includes enabling a control signal to the switching means (50) so that they divert the current to the branch line (maintaining the switching means in that condition by using the voltage provided by the now active power supply means (60)), processing the line parameters to verify the condition of the line, enabling a control signal to the means of alert (40) corresponding to the line condition, and enabling a control signal to the switching means (50) so that they once again divert the current to the main branch.

16. Method in accordance with claim 15, characterised in that
a) said processing means (30) enable an additional control signal to the voltage measurement means (10) so that they go into a disconnection state when the current has to be diverted to the branch line; and/or
b) said processing means (30) are programmed to periodically develop said operating cycle; and/or
c) said processing means (30) are programmed to maintain said switching means (50) by diverting the current to the branch line for a period of around 100 Us per operating cycle; and/or
d) said processing means (30) are programmed so that the means of alert (40) remain continuously excited, signalling the line condition during the entire duration of said line verification anomalous operating mode, regardless of the moment in the operating cycle.
